(19) United States
(12) Patent Application Publication
(10) Pub. No.: US 2015/0034738 A1
(43) Pub. Date: Feb. 5, 2015

(54) SHOWERHEAD ASSEMBLY

(71) Applicant: Ateck (Xiamen) Showers Co., Ltd., Xiamen (CN)

(72) Inventors: Jianhua Xu, Xiamen (CN); Daniel Zheng, Xiamen (CN); Changzheng Ni, Xiamen (CN)

(21) Appl. No.: 14/317,134

(22) Filed: Jun. 27, 2014

(30) Foreign Application Priority Data
Jul. 31, 2013 (CN) 201320462896.6

(51) Int. Cl. B05B 1/18

(52) U.S. Cl. CPC B05B 1/185
USPC 239/289; 239/548

(57) ABSTRACT

A showerhead assembly attached to a plumbing feature has a main body with a hollow body portion to receive incoming fluid. An outlet is formed on the bottom of the main body to release outgoing fluid, and a fluid distributing element is configured to distribute the outgoing fluid from the hollow body portion. A main sprinkler unit is mounted below the main body to connect to the outlet to receive the incoming fluid, and a plurality of fluid release points formed on the bottom for emitting fluid. Several fluid distributing plates have connectors extended from each of them to connect to the fluid distributing element for receiving fluid from the hollow body portion, and several fluid release points are formed on the bottom of the fluid distributing plate for emitting fluid. The watering area can be adjusted by extending the fluid distributing plates as required, which enables a wide variation in spray patterns flowing from the showerhead assembly.

### CROSS-REFERENCE TO RELATED APPLICATIONS

The subject matter disclosed herein is related to the subject matter contained in China Patent Appl. No. CN201320462896.6, titled SHOWER HEAD CAPABLE OF ADJUSTING SHOWERING AREA, which is incorporated herein by reference in its entirety and for all purposes.

### BACKGROUND OF THE INVENTION

1. Field of the Invention

The present invention relates to the field of a showerhead, and more specifically relates to a showerhead assembly with auxiliary sprinkler unit.

2. Description of Related Art

Most of the current bathrooms equipped with showerheads, which can pipe water toward the body. Typically, this showerhead comprises a switch for adjusting the water flow of the shower head. Conventional showerheads are merely designed to provide a single spray pattern of water to the user and are not designed to provide adjustable spray pattern to the user during shower.

China Patent Appl. No. CN201320462896.6 describes a shower head, which comprises a main body, a main sprinkling unit, an auxiliary sprinkling unit and gear units; a water storage chamber is defined in the body and a water injection pipe is arranged on the top of the body; the bottom of the body is provided with a main water distribution port; a plurality of branch pipes which are connected with the water storage chamber are radially protruded on the periphery of the body; an assembly space is reserved between the top of the main sprinkling unit and the bottom of the body, a water spraying chamber which is connected with the main water distribution port is defined in the assembly space, and the bottom of the assembly space is provided with a plurality of main water holes which are connected with the water spraying chamber; and the auxiliary sprinkling unit is provided with a plurality of equal water distribution discs which are connected to form an annular shape and are distributed on the periphery of the body, a water distribution chamber is defined in each equal water distribution disc, and the bottom of the equal water distribution disc is provided with a plurality of auxiliary water holes which are connected with the water distribution chamber, a sleeve is connected with one side of the equal water distribution disc adjacent to the body, and can do radial limit telescopic displacement along the corresponding branch pipe and each equal water distribution disc is provided with a rack which can extend into the assembly space and is driven by the gear units. The showering range can be adjusted according to the current requirements.

However, the showerhead described in those patents has a problem with its poor operability in that it is necessary to operate the gear set against water pressure, which affects the spray pattern.

In view of the foregoing, a need exists in the art for a showerhead with adjustable spray pattern. In addition, a need exists for such a showerhead assembly to be fixed well.

### SUMMARY OF THE INVENTION

In general, a showerhead assembly is provided having various aspects addressed to overcome the shortcomings in prior showerhead discussed above and provide certain other advantages.

The primary objective of the present invention is to provide a showerhead assembly to increase the spraying range of showerhead to have a relaxing shower in the bath.

In order to accomplish the above objective, one embodiment of the showerhead comprises: a main body having a hollow body portion to receive incoming fluid, an outlet formed on the bottom of the main body to release outgoing fluid, and a fluid distributing element configured to distribute the outgoing fluid from the hollow body portion; a main sprinkler unit mounted below the main body to connect to the outlet to receive the incoming fluid, and a plurality of fluid release points formed on the bottom of the main sprinkler for emitting fluid; and at least a fluid distributing plate having a connector connected to the fluid distributing element for receiving fluid from the hollow body portion, and a plurality of fluid release points formed on the bottom of the fluid distributing plate for emitting fluid.

In order to accomplish the objective, another embodiment of the showerhead comprises: a main body having a hollow body portion configured to receive incoming water, and a plurality of manifolds formed around the peripheral of the main body and connected to the hollow body portion; an inner body unit mounted below the main body, a plurality of curve recesses formed on the top surface and a knob on the bottom of inner body for rotating and fastening the inner body to the main body; and an auxiliary sprinkler unit having a plurality of water distributing plates disposed on the outer space around the main body, each of the water distributing plate having a water distributing space for receiving water from the hollow body portion for spraying water distribution and a plurality of spray holes formed on the bottom of the water distributing plate, a plurality of connectors extended from each of the water distributing plates connected to the manifolds for conducting the incoming water; wherein, the connector has a lateral arm extended toward the main body and has a slide block on the bottom of the lateral arm to match the curve recess, each of the slide block positions on each of the curve recess, thus the lateral arms slide along with the curve recesses for adjusting the water distributing plates position flexibly toward the main body.

In order to accomplish the objective, another embodiment of the showerhead comprises: a main body having a hollow body portion forming a water chamber and the top surface of the main body having an inlet portion to connect the water chamber to an water source, an main outlet formed on the bottom of the water chamber, and a plurality of manifolds formed around the periphery of the main body and coupled to the water chamber; a main sprinkler unit having a water storage space and being mounted below the main body to connect to the main outlet, and a plurality of main spray holes formed on the bottom of the main sprinkler for spraying water from the water storage space; an auxiliary sprinkler unit having a plurality of water distributing plates being concentric with the main body, each of the water distributing plate having a water distributing space and a plurality of spray holes formed on the bottom of auxiliary sprinkler unit for spraying water, a plurality of connectors extended from the water distributing spaces connected to the manifolds for conducting water from the water chamber.

The invention has a knob installed under the main sprinkler unit for rotating around axis of the showerhead, and then the slide blocks are moving along within the curve recess respectively. The connector will move toward the manifolds to adjust spraying area as water passes the water distributing space. In the structure of the curve recess, as the slide block moves within the curve recesses to any one end, it will be stuck for fixing the auxiliary sprinkler unit. Thus the water distributing plates can be scaled along the manifolds to change the spraying area of water.

Therefore, the design of the showerhead assembly is non-obvious and sufficiently inventive, and reflects a same general patentability requirement. It is noted that the present invention has the advantages that the invention provides a convenient instrument for showering and makes practical progress on the field.

### BRIEF DESCRIPTION OF THE DRAWINGS

An embodiment of the invention will now be described, by way of example only, with reference to the accompanying drawings in which:

FIG. 1 is an expanded view of the components showing a showerhead assembly according to the invention;

FIG. 2 is a cross sectional side view of the showerhead assembly according to the invention;

FIG. 3 and FIG. 3A are perspective views of the showerhead assembly according to the invention;

FIG. 4 and FIG. 4A are expended views of the showerhead assembly according to the invention;

FIG. 5 illustrates an expanded view of the showerhead assembly according to another embodiment of the invention; and

FIG. 6 illustrates an expanded view of the showerhead assembly according to another embodiment of the invention.

### DETAILED DESCRIPTION OF THE INVENTION

The following description is merely exemplary in nature and is in no way intended to limit the present teachings, applications, or uses. Those of skill in the art will recognize that the following description is merely illustrative of the principles of the invention, which may be applied in various ways to provide many different alternative embodiments.

In typical installations, referring the patent application of CN201110135318 has showed prior skills about showerhead assembly, which may not mention again in this description. The invention of the showerhead assembly is attached to a plumbing feature, e.g., a water pipe that protrudes from a wall, which has a main body with a hollow body portion to receive incoming fluid. An outlet is formed on the bottom of the main body to release outgoing fluid, and a fluid distributing element is configured to distribute the outgoing fluid from the hollow body portion. A main sprinkler unit is mounted below the main body to connect to the outlet to receive the incoming fluid, and a plurality of fluid release points formed on the bottom for emitting fluid. Several fluid distributing plates have connectors extended from each of them to connect to the fluid distributing element for receiving fluid from the hollow body portion, and several fluid release points are formed on the bottom of the fluid distributing plate for emitting fluid.

The main sprinkler unit includes a seal cap, a main spray plate and a TPR (THERMOPLASTIC RUBBER) that is positioned between the seal cap and the main spray plate, wherein the seal cap and the main spray plate are bonded through ultrasonic welding.

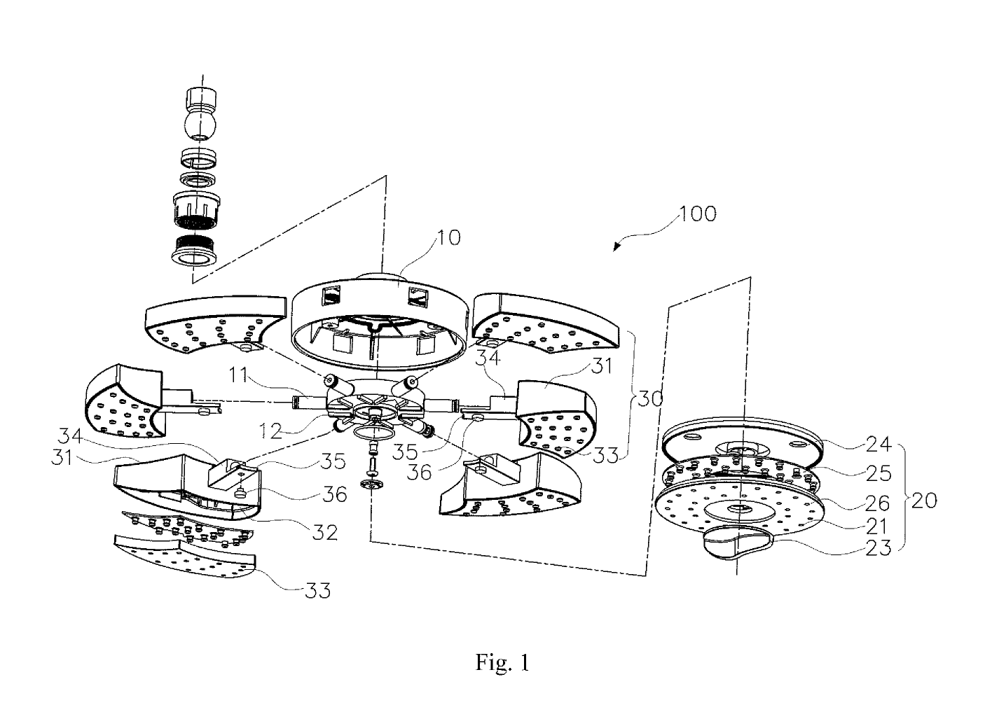

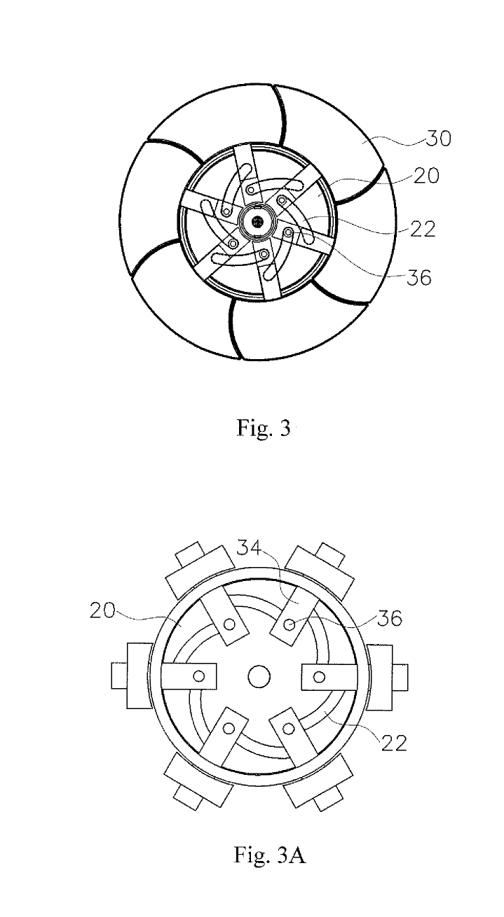

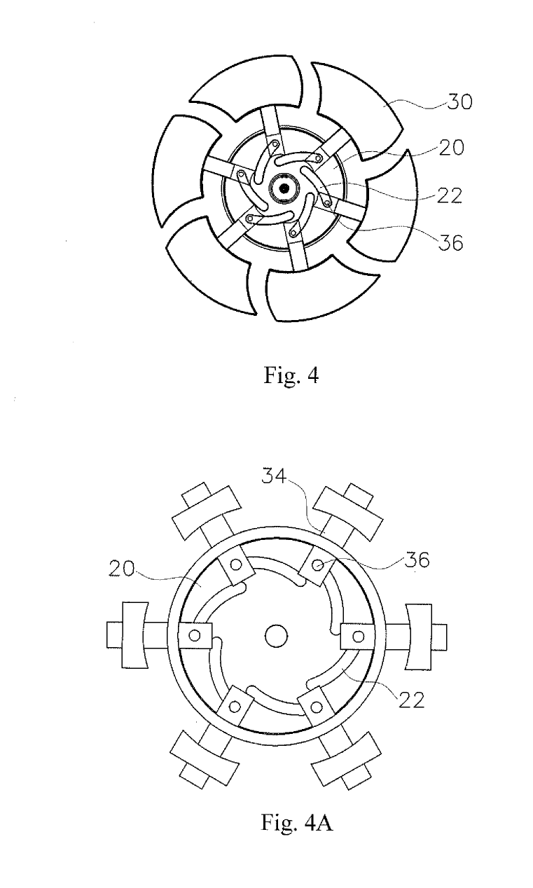

FIGS. 1, 2, 3, 4 are illustrations of the preferred embodiment in accordance with the present invention. There is shown the showerhead assembly 100 including a main body 10, a main sprinkler unit 20, and an auxiliary sprinkler unit 30.

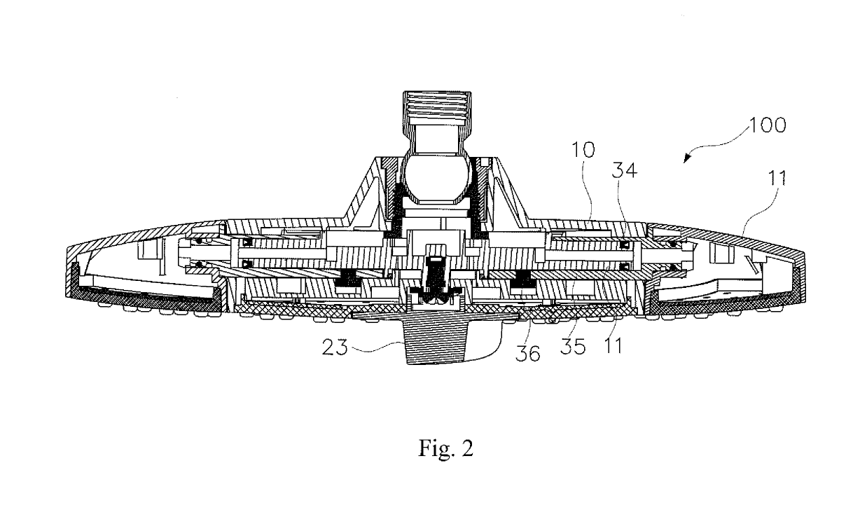

FIG. 1 is an expanded view of the components showing a showerhead assembly and FIG. 2 is its cross sectional side view according to one embodiment of the invention. The main body 10 has a hollow body portion forming a water chamber and the top surface of the main body 10 has an inlet portion to connect the water chamber to a water source. There are several manifolds 11 formed around the periphery of the main body 10 and coupled to the water chamber that a main outlet 21 formed on the bottom.

The main sprinkler unit 20 has a water storage space and is mounted below the main body 10 to connect to the main outlet 21. There are spray holes formed on the bottom of the main sprinkler unit 20 for spraying water from the water storage space.

The auxiliary sprinkler unit 30 has several water distributing plates 31 being concentric with the main body 10, and each of the water distributing plate 31 has a water distributing space 32 and spray holes 33 formed on the bottom of auxiliary sprinkler unit 30 for spraying water. A connector 34 is extended from the water distributing space 31 connected to the manifold 11 for conducting water from the water chamber.

Furthermore, the connector 34 has a lateral arm 35 extended toward the main body 10 and a slide block 36 on the bottom of the lateral arm 35 to match the curve recess 22. Each of the slide block 36 positions each of the curve recess 22, thus the lateral arm 35 slides along with curve recess 22 for moving the water distributing plate 31 toward radial and circumferential direction corresponding to the main body 10 and provides limit expansion for the water distributing plates 31 corresponding to the main body 10.

Accordingly, a knob 23 is installed under the main sprinkler unit 20 for rotating around axis of the showerhead, and then the slide blocks 36 are moving along within the curve recess 22 respectively. The connector 34 will move toward the manifolds to adjust spraying area as water passes the water distributing space 32. In the structure of the curve recess 22, as the slide block 36 moving within the curve recess 22 to any one end, it will be stuck for fixing the auxiliary sprinkler unit 30. Thus the water distributing plates 31 can be scaled along the manifolds 11 to change the spraying area of water.

By the way, the moving of the lateral arms 35 must keep steady. The bottom of the main body 10 has a plurality of rib groups 12 corresponding to the lateral arms 35, for each rib group 12 having two parallel ribs to contact the lateral sides of the lateral arm 35. The moving of the lateral arms 35 is guided by the rib group 12 for smooth operation.

The main sprinkler unit 30 includes a seal cap 24, a spray plate 26 and a TPR (THERMOPLASTIC RUBBER) 25 that is positioned between the seal cap 24 and the spray plate 26, wherein the seal cap 24 and the spray plate 26 are bonded through ultrasonic welding.

In another embodiment, a main body has a hollow body portion configured to receive incoming water, and a plurality of manifolds formed around the peripheral of the main body and connected to the hollow body portion. An inner body unit is mounted below the main body and formed a plurality of curve recesses on the top surface of inner body, and a knob on the bottom of main body for rotating and fastening the inner body. And an auxiliary sprinkler unit has a plurality of water distributing plates disposed on the outer space around the main body, each of the water distributing plate has a water distributing space for receiving water from the hollow body portion for spraying water and a plurality of spray holes are formed on the bottom of auxiliary sprinkler unit. A connector is extended from the water distributing space connected to the manifolds for conducting water.

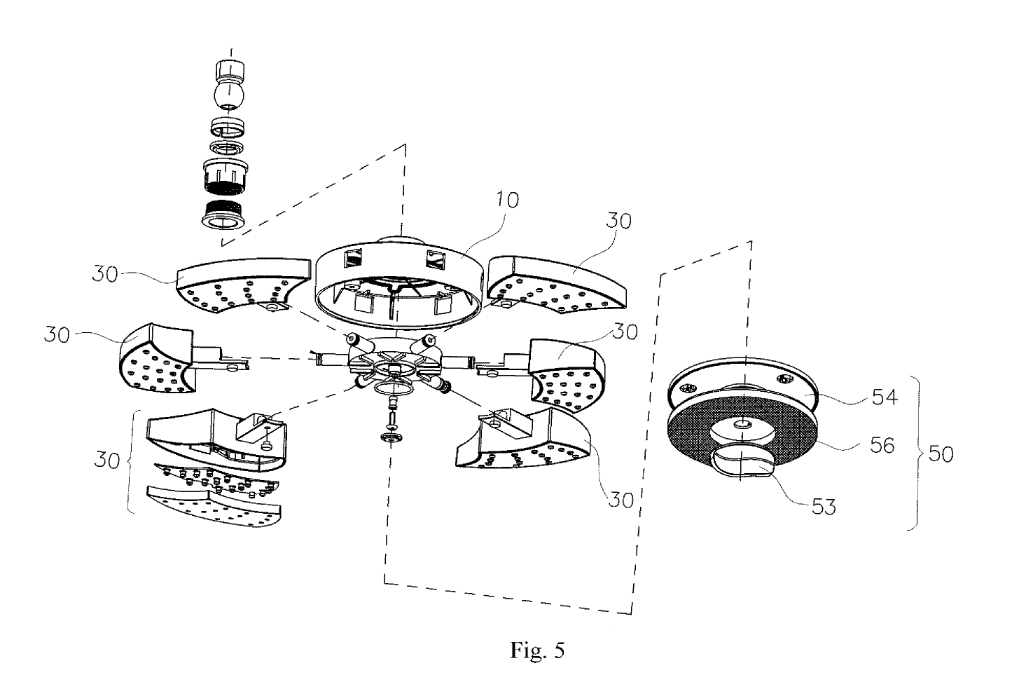

Referring to FIG. 5, an expanded view of the components shows another embodiment of the showerhead assembly 100. The main body 10 and the auxiliary sprinkler unit 60 have same structures abovementioned. An inner body unit 50 is mounted below the main body unit 10 and curve recesses are formed on the top for moving the water distributing plate 31 toward radial and circumferential direction corresponding to the main body 10. A knob 53 is installed under the inner body unit 50 for rotating it around axis of the showerhead to tighten the inner body unit 50.

The inner body unit 50 comprises a seal cap 54 and an audio speaker 56 which are bonded through ultrasonic welding. The users can listen to the music while taking their showers for pleasure.

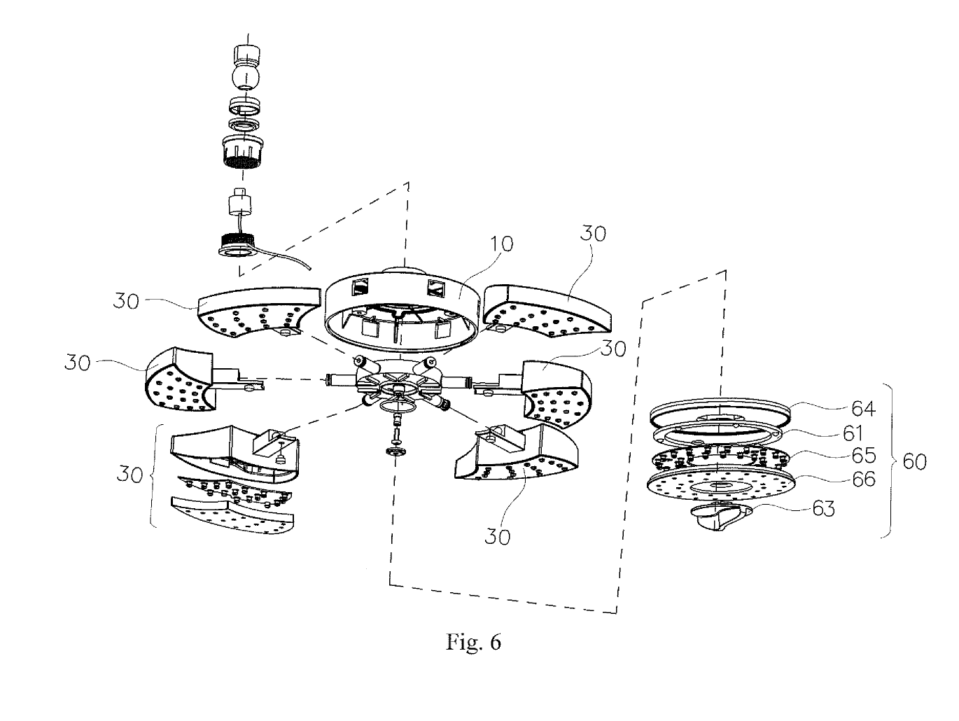

Referring to FIG. 6, an expanded view of the components shows another embodiment of the showerhead assembly 100. The main body 10 and the auxiliary sprinkler unit 30 have same structures abovementioned. An inner body unit 60 is mounted below the main body unit 10. Curve recesses are formed on the top of the inner body unit 60 for moving the water distributing plate 31 toward radial and circumferential direction corresponding to the main body 10. A knob 63 is installed under the inner body unit 60 for rotating it around axis of the showerhead.

Accordingly, the inner body unit 60 comprises a seal cap 64, a LED panel 61, a main spray plate 66 and a TPR (THERMOPLASTIC RUBBER) layer 65. The TPR layer 65 is positioned between the seal cap 64 and the main spray plate 66, and the LED panel is positioned between the seal cap 64 and the TPR layer 65. Wherein the seal cap 64 and the main spray plate 66 are bonded through ultrasonic welding. The illumination of the water droplets by the lights creates a pleasant showering experience for the user.

Accordingly, each connector has a lateral arm extended toward the main body and has a slide block on the bottom of the lateral arm to match the curve recess formed on the top surface of the inner body unit and a knob positioned on the bottom. The slide block positions each of the curve recess, thus the lateral arm slides along with curve recess for adjusting the water distributing plate position flexibly toward the main body. The curve recesses for slide blocks slide the water distributing plates to move toward radial and circumferential direction corresponding to the main body.

The invention is non-obvious and sufficiently inventive, and reflects a same general patentability requirement. It is noted that the present invention has the advantages that the invention provides a convenient instrument for showering and makes practical progress on the field.

While the invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A showerhead assembly, comprising:
a main body having a hollow body portion to receive incoming fluid, an outlet formed on the bottom of the main body to release outgoing fluid, and a fluid distributing element configured to distribute the outgoing fluid from the hollow body portion;
a main sprinkler unit mounted below the main body to connect to the outlet to receive the incoming fluid, and a plurality of fluid release points formed on the bottom of the main sprinkler for emitting fluid; and
at least a fluid distributing plate having a connector connected to the fluid distributing element for receiving fluid from the hollow body portion, and a plurality of fluid release points formed on the bottom of the fluid distributing plate for emitting fluid.

2. The showerhead assembly as claimed in claim 1, wherein the main sprinkler unit includes a seal cap, a main spray plate and a TPR (THERMOPLASTIC RUBBER) layer that is positioned between the seal cap and the main spray plate, wherein the seal cap and the main spray plate are bonded through ultrasonic welding.

3. A showerhead assembly, comprising:
a main body having a hollow body portion configured to receive incoming water, and a plurality of manifolds formed around the peripheral of the main body and connected to the hollow body portion;
an inner body unit mounted below the main body, a plurality of curve recesses formed on the top surface and a knob on the bottom of inner body for rotating and fastening the inner body to the main body; and
an auxiliary sprinkler unit having a plurality of water distributing plates disposed on the outer space around the main body, each of the water distributing plate having a water distributing space for receiving water from the hollow body portion for spraying water distribution and a plurality of spray holes formed on the bottom of the water distributing plate, a plurality of connectors extended from each of the water distributing plates connected to the manifolds for conducting the incoming water;
wherein, the connector has a lateral arm extended toward the main body and has a slide block on the bottom of the lateral arm to match the curve recess, each of the slide block positions on each of the curve recess, thus the lateral arms slide along with the curve recesses for adjusting the water distributing plates position flexibly toward the main body.

4. The showerhead assembly as claimed in claim 3, wherein a main outlet is formed on the bottom surface of the water chamber, the inner body has a water storage space connected to the main outlet, and a plurality of main spray holes formed on the bottom of the inner body connected to the water storage space.

5. The showerhead assembly as claimed in claim 3, wherein the inner body includes a seal cap, a main spray plate and a TPR (THERMOPLASTIC RUBBER) layer that is positioned between the seal cap and the main spray plate, and the seal cap and the main spray plate are bonded through ultrasonic welding.

6. The showerhead assembly as claimed in claim 3, wherein the slide blocks are fixed on the bottom of lateral arms with connection pins.

7. The showerhead assembly as claimed in claim 3, wherein the bottom of the main body has a plurality of rib groups corresponding to the lateral arms, for each of the rib group having two parallel ribs to contact the lateral sides of the lateral arm.

8. The showerhead assembly as claimed in claim 3, wherein the inner body unit comprises: a seal cap, a LED panel, a main spray plate and a TPR (THERMOPLASTIC RUBBER) layer that is positioned between the seal cap and the main spray plate, wherein the LED panel is positioned between the seal cap and the TPR layer, and the seal cap and the main spray plate are bonded through ultrasonic welding.

9. The showerhead assembly as claimed in claim 3, wherein the inner body unit comprises: a seal cap and an audio speaker, the seal cap and the audio speaker are bonded through ultrasonic welding.

10. A showerhead assembly, comprising:
a main body having a hollow body portion forming a water chamber and the top surface of the main body having an inlet portion to connect the water chamber to an water source, an main outlet formed on the bottom of the water chamber, and a plurality of manifolds formed around the periphery of the main body and coupled to the water chamber;
a main sprinkler unit having a water storage space and being mounted below the main body to connect to the main outlet, and a plurality of main spray holes foamed on the bottom of the main sprinkler for spraying water from the water storage space;
an auxiliary sprinkler unit having a plurality of water distributing plates being concentric with the main body, each of the water distributing plate having a water distributing space and a plurality of spray holes formed on the bottom of auxiliary sprinkler unit for spraying water, a plurality of connectors extended from the water distributing spaces connected to the manifolds for conducting water from the water chamber;
wherein, each of the connector has a lateral arm extended toward the main body and has a slide block on the bottom of the lateral arm to match the curve recess, each of the slide block positions each of the curve recess, thus the lateral arms slide along with curve recesses for moving the water distributing plates toward radial and circumferential direction corresponding to the main body and providing limit expansion for the water distributing plates corresponding to the main body.

11. The showerhead assembly as claimed in claim 10, wherein the slide blocks are fixed on the lateral arms with connection pins.

12. The showerhead assembly as claimed in claim 10, wherein the bottom of the main body has a plurality of rib groups corresponding to the arms, for each rib group having two parallel ribs to contact the lateral sides of the lateral arm.

13. The showerhead assembly as claimed in claim 10, wherein the main sprinkler unit includes a seal cap, a main spray plate and a TPR (THERMOPLASTIC RUBBER) layer that is positioned between the seal cap and the main spray plate, wherein the seal cap and the main spray plate are bonded through ultrasonic welding.
